(19) United States
(12) Patent Application Publication
(10) Pub. No.: US 2016/0078357 A1
(43) Pub. Date: Mar. 17, 2016

(54) System and Method For knowledge transfer and machine learning via dimensionalized proxy features

(71) Applicant: Ignitrium, Inc. DBA Prefrent, Hayden, ID (US)

(72) Inventors: Robert Michael Hust, Coeur d'Alene, ID (US); Curt Casmer Ogieglo, Hayden, ID (US)

(73) Assignee: Ignitrium, Inc. DBA Prefrent, Hayden, ID (US)

(21) Appl. No.: 14/484,277

(22) Filed: Sep. 12, 2014

(51) Int. Cl. G06N 5/04; G06N 5/02

(52) U.S. Cl. CPC G06N 5/048; G06N 5/02

(57) ABSTRACT

This invention describes a system for utilizing dimensionalized archetypical or proxy representations of a person, place, thing, concept or construct and generally, a method for utilizing such representations for the purposes of information retrieval, knowledge management, and machine learning whereby the representations contribute to enhanced speed, contextual acuity, and overall value of the information stored within the system, as well as the easy utilization of the archetypical or proxy representations by such means or methods as weighted sorts, support vector machines, probabilistic filters, or other means whereby one or more of the dimensionalized tags or features represented by the affinitomic elements are utilized to make a selection.

The invention of this method involves no Federal, or publicly sponsored research.

### BACKGROUND OF THE INVENTION

1. Field of Invention

This invention relates to knowledge discovery and information management as well as the transmission of constructs for use with artificially intelligent systems and machine learning and information management expand.

2. Prior Art

In the past, and current practice outside this invention information about particular topics has been marked, automatically, routinely, or systematically with meta-data called “tags” or “keywords” to assist in information retrieval and to organize data as a “type”. These tags can be generally thought of as a “bag-of-features” and are stored either as meta-data within a document itself, and or within a database, and or collection, whereby the tags are ascribed by some means to the document, database, collection. A practice has developed that an item with a particular tag is by some means related to any other item with the same tag.

Some systems are sophisticated enough to calculate similarity based on the number of tags that are in common between a number of items—the greater the number of common tags, the more similarity there is between the individual representations of data within the collection of data. This practice, markedly inferior to our invention, becomes untenable when a collection has either too few or too many tags. With too few tags, similarities between documents become less meaningful and less valuable unless the tags have been assigned simply as categorical ontologies, which limits their use within the system. Information retrieved using a sparse or limited number of tags, unless the tags were simply assigned to ascribe a categorical ontology, is generally of a lower matching quality than a regular expression query against the body of the document. Conversely, when sets of data are compared that use too many tags or embody too many tags in a query, the value of the result is also degraded. When comparing a set of documents based on a large number of common tags, the data that is returned is often of too broad an interest to be particularly valuable. This can be refined by using the tags to construct a filter or a complex query. However, many systems, particularly those systems on the Internet, are not constructed in a manner that effectively allow for such queries by the end user or the use of complex filters. We refer to these systems as being “one dimensional.” A previous system proposed, the object of an earlier invention described in patent application Ser. No. 14/194,816 filed with the United States Patent and Trademark Office, offered significantly better information retrieval and calculations of similarity and context by improving upon how tags are discovered, used, stored, and evaluated within a system.

This current invention deals with the sharing and distribution of such “dimensionalized” tag constructs and imparts a means of creating representational proxies, such that these proxies become representational constructs for use with intelligent systems.

Previous, and current web based systems use and have used meta and micro-data formats in an attempt to enhance an html document's ability to interact intelligently with systems. Such data is usually written as a script into the header of the document, in such a way that appropriately configured web servers and indexing systems could deliver documents in a more appropriate manner. This meta-data consumes valuable storage space and resources, but much of it has become, and continues to become legacy, and is no longer used by systems. Our invention proposes instead, that a smaller set of data, data that is dimensionalized and therefore more meaningful and useful be written either into the document itself or linked to the document in such a manner that it represents the context and content of the document for both query based systems and machine learning mechanisms. Such a practice would be far more valuable for both current and future web-based systems, because it would reduce the need and cost to supporting legacy practices, contribute to an overall increase in network speeds, and enable shared discovery across systems.

### OBJECTS AND ADVANTAGES

Accordingly, several objects and advantages of the invention follow. Those systems and methods within computing that rely on tags or tokenized features or sets of features, or other elements associated with categorical ontologies, will be greatly enhanced by this invention. This includes web media, mobile devices, information retrieval systems, knowledge discovery systems, and artificial intelligence. This invention allows items, objects, and articles, within electronic media, to be more quickly and effectively sorted and grouped. The invention allows for tags and features to be stored in a manner that allows them to be better and more effectively utilized for knowledge discovery and information retrieval. The invention allows for the creation of a small and efficient informational proxy element to represent larger data, collections and structures, speeding comparison and retrieval. The invention allows for the construction of an “archetype” comprised of “descriptors”, “draws”, and “distances” that serves to dimensionalize tags, making their use within a system faster and more effective. While dimensionalized tags can be stored as a bag-of-features, the preferred embodiment of the invention stores these tags in “JSON object” that is used to construct a kernel matrix that, in turn, can be used to enact support vector machines for deeper knowledge discovery and comparison. A further benefit of the invention is the reduction of computing resources as a result of shared elements across a collection being re-tokenized as a single elements, replacing larger collections of elements—this results in less computing complexity at runtime. A further advantage of the invention is that the archetypes act as proxies, can be shared across systems and platforms. The overarching advantage of the invention, is that information embodied in elements of the invention become self-aware of their context and use, allowing said elements to become self-organizing and knowledge discovery to be further automated.

Further objects and advantages will become apparent from a consideration of the ensuing description.

### SUMMARY

This SYSTEM AND METHOD FOR KNOWLEDGE TRANSFER AND MACHINE LEARNING VIA DIMENSIONALIZED PROXY FEATURES is comprised of a set of archetypes, proxies, or kernel matrices with each being comprised of one or more affinitomic element, tag or feature and one or more links or references to the real person, place, thing concept or construct that is represented by the archetype, proxy or kernel matrix. An archetype may optionally include encoded affinitomics that represent a larger collection of affinitomic elements, proxies, or kernel matrices. An archetype, proxy or matrix may optionally include a “payload” that is delivered when a selection criteria is met. The system is further comprised of a means and rules for evaluating the archetypes, proxies or matrices and assigning them a score based on similarities to a separate set of elements—such means could include weighted sorts, support vector machines, probabilistic filters, or other means whereby one or more of the dimensionalized tags or features represented by the affinitomic elements are utilized to make a selection. The system is further comprised of a data store for the affinitomic archetypes, proxies, or matrices such that they may be efficiently indexed and retrieved based on distinct criteria. The system is optionally further comprised of a means to discover archetypes or matrices within a set or sets of matching elements and encode these sets as a separate archetype or proxy referenced as a single affinitomic element. By this means the system can both minimize storage and nest affinitomic archetypes. The system is optionally further comprised of a means to discover affinitomics from a data source via such methods as language processing or feature extraction and automatically create archetypes that are representational of said data source. The system is optionally further comprised of a mechanism to infer or assign the domain or context within which an archetype is to be used, such as a categorical ontology. The system is optionally further comprised of a means of encrypting archetypes and collections of archetypes such that they can be used, opened, or read only by those entities possessing appropriate keys.

### BRIEF DESCRIPTION OF SEVERAL VIEWS OF THE DRAWINGS

The embodiments of this invention are illustrated by way of example and not limitation in the figures of the accompanying drawings, in which like references indicate similar elements and in which:

FIG. 1.—Illustrates the JSON representation of an archetype

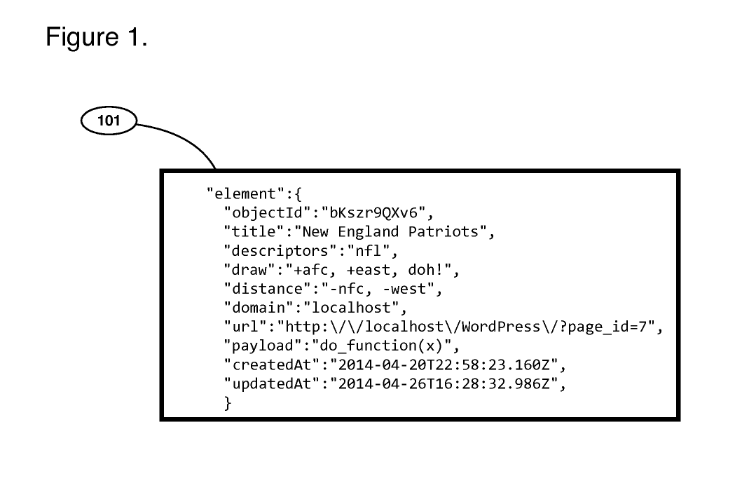

FIG. 2.—Illustrates storage strategies for archetypes

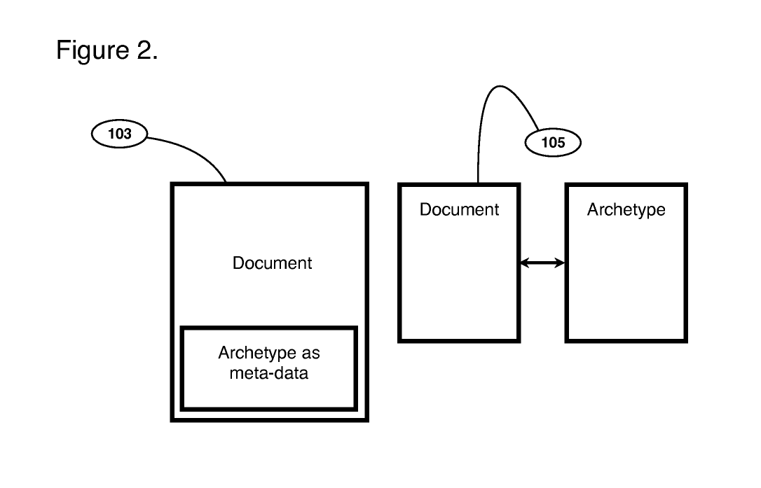

FIG. 3.—Illustrates archetype composition and elements of an archetype

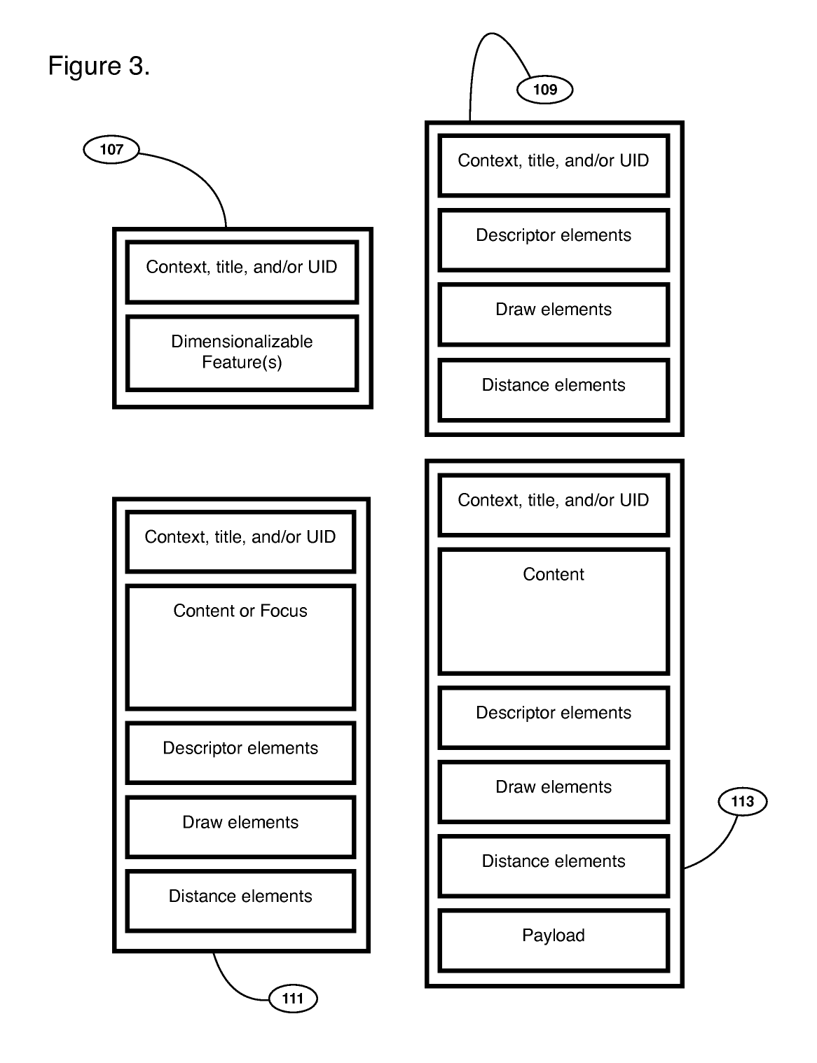

FIG. 4.—Illustrates processing archetypes for affinity

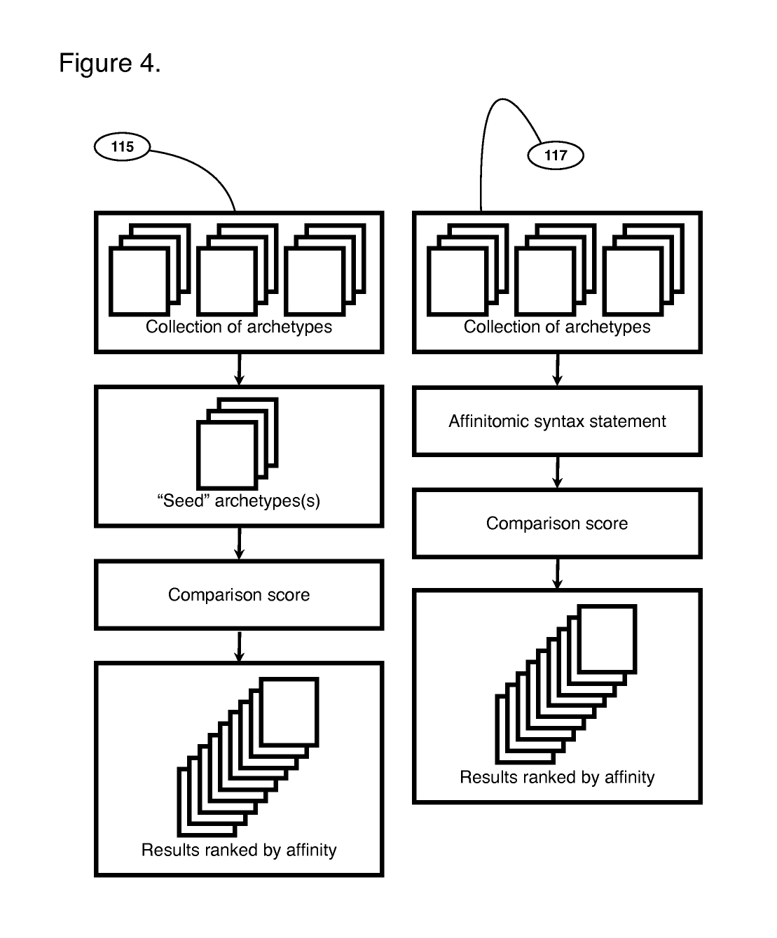

FIG. 5.—Illustrates kernel storage and evaluation strategies for affinitomics

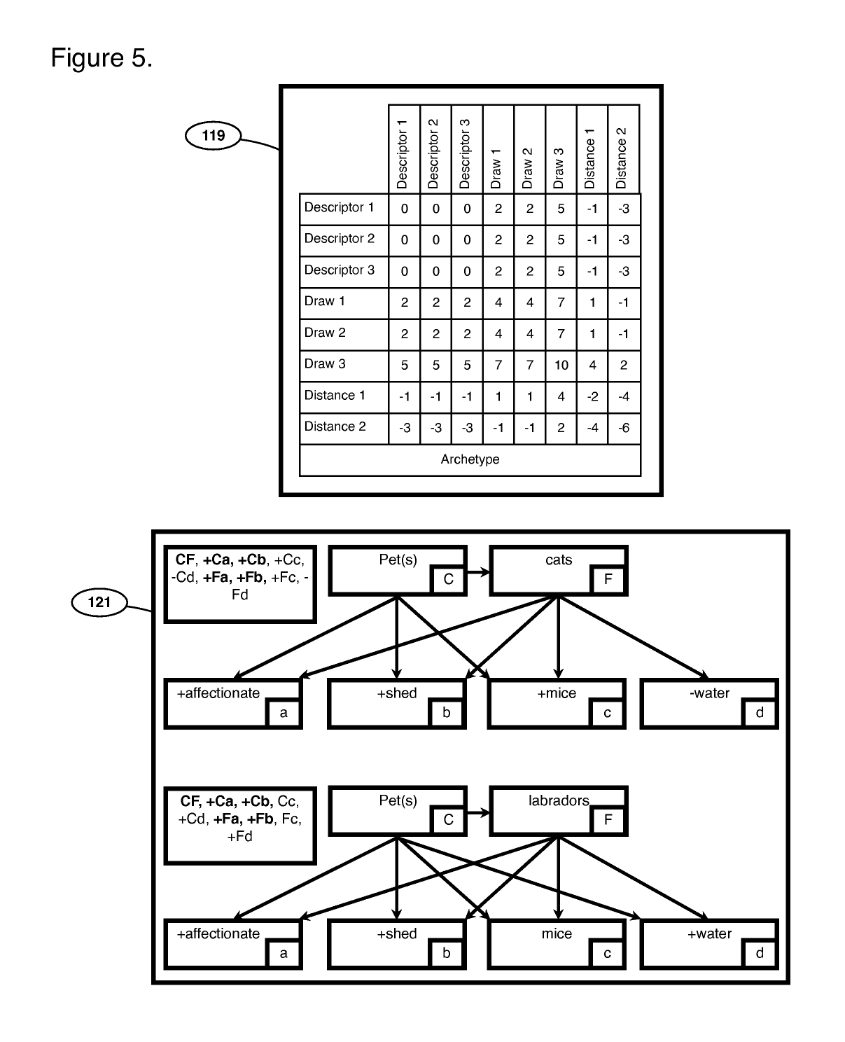

FIG. 6.—Illustrates encoding process for affinitomic elements

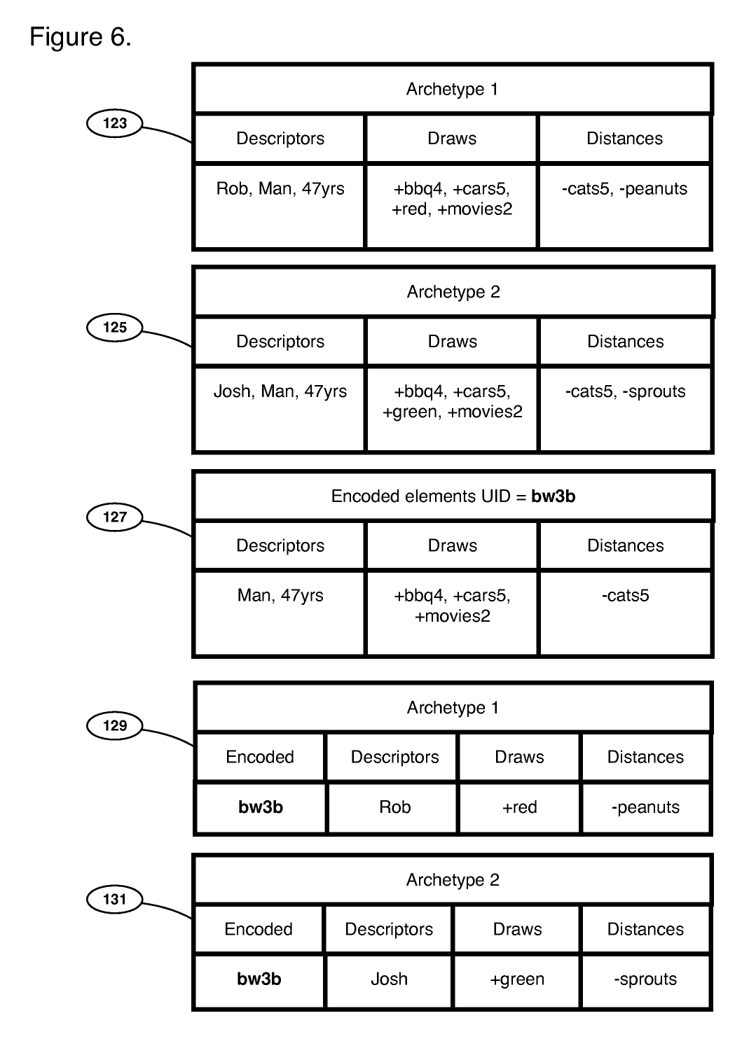

FIG. 7.—Illustrates storing multiple affinitomics as a summed kernel matrix

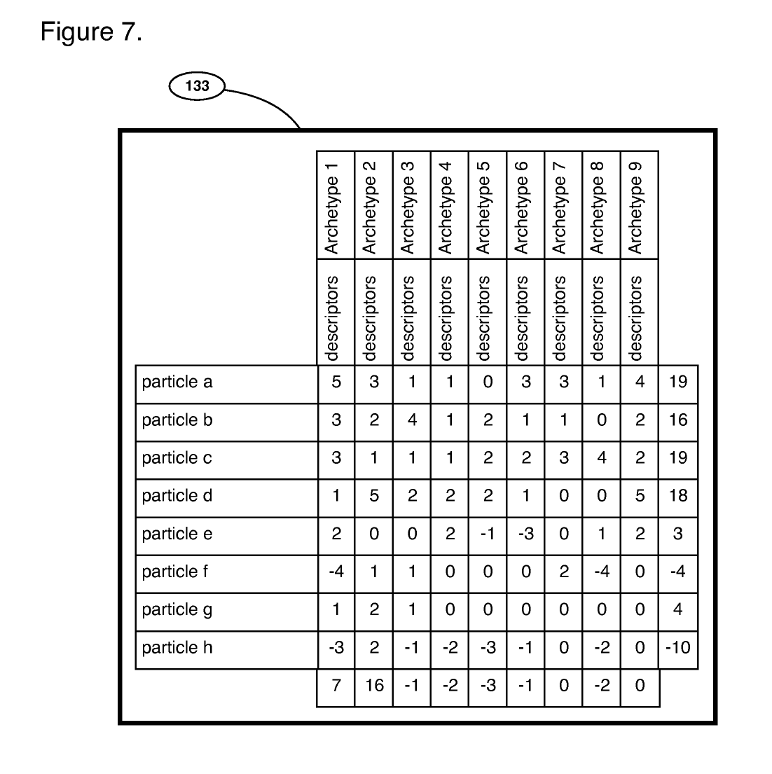

FIG. 8.—Illustrates storing multiple affinitomics as an indexed summed kernel matrix

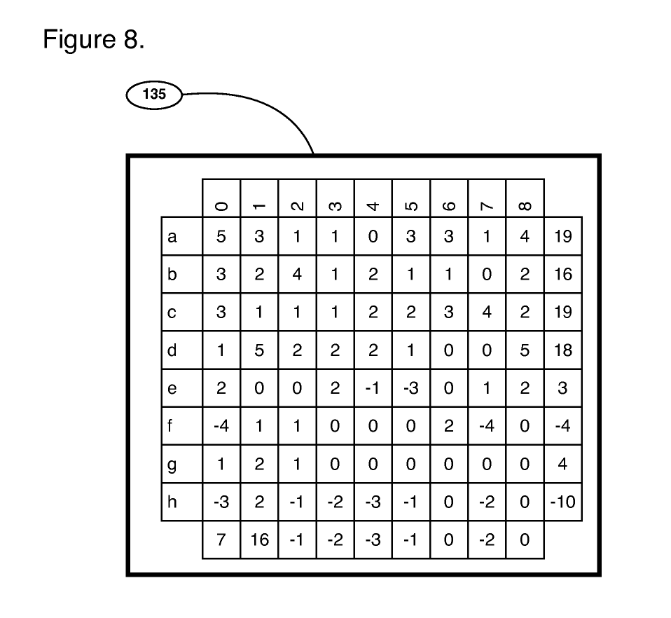

FIG. 9.—Illustrates discovering a common archetype, useful for encoding

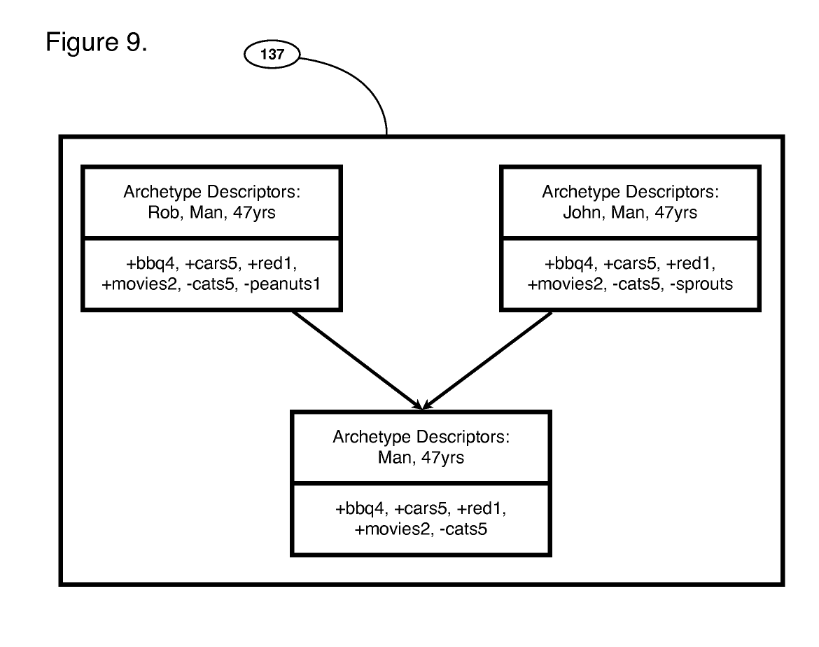

### DETAILED DESCRIPTION

For purposes of clarity, we define the following:
Affinitomics refers to the practice of utilizing individual tag elements consisting of descriptors (defined below), draws (defined below), and distances (defined below) or the application of these elements, to compare proxy archetypes within and across collections of archetypes for the purposes of knowledge discovery, information retrieval and information management. This comparison results in a value that represents an affinity or nearness.
Archetypes refer to a proxy representation of a real person, place, thing, concept or construct. Said proxy representation is minimally comprised of at least one instance of a descriptor, draw, or distance, and a link or reference to or description of the real person place thing, or concept being represented by the archetype.
Descriptor elements, or descriptors, or neutral particles are informational tags that describe characteristics of a person, place, thing, concept or construct. A descriptor is an affinitomic element.
Draw elements, or draws, or positive particles, are informational tags that connote an affinity to or toward a person, place thing, concept or construct. A draw is an affinitomic element.
Distance elements, or distances, or negative particles, are the opposite of Draws and connote an avoidance or predilection away from a person, place, thing, concept or construct. A distance is an affinitomic element.
Encoded elements are comprised of two or more affinitomic elements that have been reduced and written as a single element within an affinitomic archetype
An affinitomic genome is a set or list of encoded affinitomic elements that reference a number of external archetypes as part of a tree, schema, or other structure that infers context or use.
Affinitomic payload or payload refers to information, data, or functions that are enacted when an archetype is matched or selected in a system.
Amplitude refers to a positive or negative value associated with an element, particle, draw or distance. In the preferred embodiment covered in this disclosure, it ranges from −5 to 5, but should not be construed as being limited to these values.
Summed kernel matrix refers to matrices used as kernels where the cells of the kernel are comprised of sums of one or more functions.
JSON Object refers to an unordered collection of name/value pairs. Its external form is a string wrapped in curly braces with colons between the names and values, and commas between the values and names. The internal form is an object having get and opt methods for accessing the values by name, and put methods for adding or replacing values by name. The values can be any of these types: Boolean, Array, Object, Number, String, or a NULL object. A JSON Object constructor can be used to convert an external form JSON text into an internal form whose values can be retrieved with the get and opt methods, or to convert values into a JSON text using the put and toString methods. A get method returns a value if one can be found, and throws an exception if one cannot be found. An opt method returns a default value instead of throwing an exception, and so is useful for obtaining optional values.

This SYSTEM AND METHOD FOR KNOWLEDGE TRANSFER VIA DIMENSIONALIZED PROXY FEATURES is comprised of a set of archetypes with each archetype being comprised of one or more affinitomic elements, tags or features stored either as a kernel matrix or in such a way that they can construe a kernel matrix and one or more links or references to the real person, place, thing concept or construct that is represented by the archetype. An archetype may optionally include encoded affinitomics that represent a larger collection of affinitomic elements. An archetype may optionally include a payload that is delivered when a distinct criteria is met.

The system is further comprised of a means and rules for evaluating the archetypes and assigning them a score based on similarities to a separate set of affinitomic elements—such means could include weighted sorts, support vector machines, probabilistic filters, or other means whereby one or more of the dimensionalized tags represented by the affinitomic elements are utilized to make a selection.

The system is further comprised of a data store for the affinitomic archetypes such that they may be efficiently indexed and retrieved based on distinct queries.

The system is optionally further comprised of a means to discover archetypes with a set or sets of matching affinitomic elements and encode these sets as a separate archetype referenced as a single affinitomic element. By this means the system can both minimize storage and nest affinitomic archetypes.

The system is optionally further comprised of a means to discover affinitomics from a data source via such methods as language processing or feature extraction and automatically create archetypes that are representational of said data source.

The system is optionally further comprised of a mechanism to infer or assign the domain or context within which an archetype is to be used Within a categorical ontology.

The system is optionally further comprised of a means of encrypting archetypes and collections of archetypes such that they can be read, opened, or used, only by those entities possessing appropriate keys.

Archetypes are either constructed as 103 meta-data embedded into a document or 105 attached by some means to the data they represent, or they are discovered via a processing method that relies on some means of feature extraction. In the case of textual data, a language processing system would utilize an understanding of a syntax to extract affinitomic features. Such a syntax, in its preferred embodiment is described as having a nucleus consisting of one or more words, and various positive and negative particles ascribed to the nucleus.

An archetype can be defined within a system by assigning it a name or title and ascribing descriptors, draws, and distances, and 103 either attaching it directly to a data type as meta-data, or 105 linking it to the data it represents by some means. An archetype must include 107 at least a context, title or name, as well as at least one dimensionalizable feature, including, but not limited to keywords, ontological or taxonomical assignations, tags, 109 descriptors, draws, or distances—the preferred 111 embodiment utilizes some combination of descriptors, and or draws, and or distances representing a person, place, thing, concept or construct. The preferred embodiment is for the archetype to include a context, name or “Unique Identifier” (UID), content describing the focus and use of the archetype (document body), one or more descriptor elements, one or more draw elements, and one or more distance elements. Optionally, an archetype 113 can include a payload of data, code fragments, hyperlinks, or any other useful construct. The payload is delivered if a selection or match is made when delivered when a distinct criteria is met. Archetypes can be further refined if given a context or schema that defines when and if they will be evaluated.

Evaluating Archetypes within the system is done by 115 comparing one or more archetypes to a plurality of archetypes 117 or by comparing a statement or query containing elements that comprise an archetype to a plurality of archetypes. The most simplistic comparison of archetypes calculates the magnitude of common affinitomic elements between an initiating archetype and a prospective archetype or collection of prospective archetypes as a sum. In a preferred embodiment, prospective archetypes would be gathered from a collection wherein the prospects shared one or more descriptors, and or one or more draws and or one or more distances. Commonalities between descriptors, draws, and distances add one to the sum. Amplitudes of matching elements above one are added to the sum as well. In the preferred embodiment, amplitudes are as high as five and as low as negative-five but these values are not to be construed as having to be limited. The resulting score for each prospect compared to the initiating archetype, in concert with any ascribed variables or limitations, determines the rank of the prospect. In cases where there are matching affinitomic distances, the negative amplitudes are converted to positive associations in the preferred embodiment. The result of the comparison is a sorted list of prospect archetypes based on the score. The preferred embodiment of comparison for exceedingly large collections of complex archetypes, where a sorting algorithm is too computationally expensive, is to consider the affinitomic elements as one or more of various types of kernel 119 133 135 and apply various 121 kernel methods to compare the archetypes—in such a case, the resulting list would could be expected to use probabilities. In the current preferred embodiment, the elements for constructing these kernels are stored as 101 JSON objects wherein the elements of a “unique identifier” (UID), title, domain, descriptors, distance, draw, Universal Resource Locator (URL)/Universal Resource Identifier (URI), payload, date created, date updated, are defined by the object. The system wherein the affinitomic archetypes are used, supplies the instructions on how to comprise the specific kernel from one or more of these JSON (or similarly defined) objects.

Encoding affinitomics is a preferred method to reduce computational expense and archetype size. Encoded elements can be either evaluated directly as a singular element, or its constituent elements can be analyzed. Encoded elements are essentially affinitomic archetypes used as descriptors, draws, and or distances. These archetypes are comprised of affinitomic elements that occur as a pattern with great frequency amongst the pool of prospective archetypes. As an example, given an archetype 123 that has descriptors Rob, Man, 47 yrs; draws of +bbq4, +cars5, +red1, +movies2; and distances −cats5, −peanuts—then given an archetype 125 that has descriptors Josh, Man, 47 yrs; draws +bbq4, +cars5, +green, +movies2; and distances of −cats5, −sprouts—it can be discerned that the descriptors of Man, 47 yrs; the draws of +bbq4, +cars5, +movies2; and the distance of −cats5 are held in common. For purposes of brevity and reducing complexity it is useful to create an 127 encoded archetype, or encoding element with a UID that contains these elements. Thereafter, 139 131 archetypes can refer to the encoded archetype instead of repeating the shared descriptors, draws, and distances. So a subsequent archetype with common descriptors, as well as common draws, and distances can be reduced in size and complexity by using the encoded elements.

Discovery of archetypes 137 from a corpus or sets of data is possible via a variety of language processing methods in the case of written text, or other feature extraction methods appropriate to the data being processed in the case of other data types. In the preferred embodiment, a language processing heuristic is employed that uses WordNet to facilitate part of speech, stemming, and synonym set detection as well as any one of a number of techniques for word sense disambiguation (both supervised or unsupervised) such that the predominate subjects become descriptors, nouns and verbs describing acts or actions that are popular in relationship to the subject(s) become draws, and negatively indicated actors or actions become distances. Because the affinitomics are stored such that they can be used as kernels, the new archetype can be recursively evaluated for “fitness” against current archetypes. It should be recognized that not all processing involves words or language. In such cases WordNet would be replaced with an appropriate ontological, or process construct, such that the type, and or meaning, and or value, and or use of the person, place, thing, concept, or constructs within the archetypes could be evaluated appropriately within the system.

Archetypes are stored via a means that allows them to be easily read as kernel matrices. Each archetype can be constructed as a graph of either all elements within the archetype represented symmetrically along two axis or with descriptors along one axis and draws and distances along another. These 133 135 matrices can alternately be represented as graphs of the entire collection of archetypes, with values present for the individual archetype being represented. In the preferred embodiment, a matrix is constructed for both the individual archetype, and the archetype within the collection. This allows for rapid sorting at run time, and affinity indexing for rapid information retrieval and caching.

Archetypes are either stored with, or linked to, the data they represent. For smaller collections of data it is appropriate to store affinitomics with or within the data they represent as meta-data since sorting and comparison is computationally inexpensive. For larger collections it is more appropriate for an affinitomic archetype to be linked to the data. Archetypes stored separately are, in the preferred embodiment, compared to all other archetypes within the collection and indexed in such a manner as to reflect similarities between archetypes. This practice enables efficient indexing by various means, as well as caching of archetypes that are commonly retrieved.

1: What is claimed is a method and system for comparing a representational proxy for a real person, place, thing, concept, or construct within a computer system where such proxy is used to store tag elements for measuring or inferring affinity/nearness, or likelihood, wherein the system is comprised of a means of assigning a computer representation of a person, place, thing, concept or construct to a representation, archetype or proxy of said person, place, thing, concept or construct; a means of storing said representation such that it can be either securely and or publicly accessed by any such system that employs or seeks to employ such proxies or archetypes; a means of retrieving such proxies and archetypes which are deemed related to a specific feature or set of features within the proxy, archetype, or material represented by the proxy or archetype;
The method and system of claim 1, further comprised of a means to construct a variety of kernel matrices from the elements and or features.
1. The method and system of claim 1, further comprised of a means whereby the archetypes or proxies are indexed or cached to affect rapid retrieval of those archetypes or proxies deemed related.
2. The method and system of claim 1, further comprised of a machine learning element that retrieves, evaluates, enhances, and or changes, improves or replaces the original archetype or proxy within the data store.
3. The method and system of claim 1 wherein the proxies and or archetypes and or constructs, such as kernels, constructed from these archetypes are, themselves, utilized as features to construct a proxy or archetype.
4. The method and system of claim 1 wherein the elements of the system reside across multiple systems that communicate or evaluate proxy or archetypical representations.
5. The method and system of claim 1 where the proxy representations are affinitomic archetypes.
